(19) United States
(12) Patent Application Publication
(10) Pub. No.: US 2025/0253391 A1
(43) Pub. Date: Aug. 7, 2025

(54) SOLID ELECTROLYTE, COMPOSITE MATERIAL, BATTERY, AND PRODUCTION METHOD FOR SOLID ELECTROLYTE

(71) Applicant: TOYOTA JIDOSHA KABUSHIKI KAISHA, Toyota-shi (JP)

(72) Inventor: Keiichi MINAMI, Tagata-gun (JP)

(73) Assignee: TOYOTA JIDOSHA KABUSHIKI KAISHA, Toyota-shi (JP)

(21) Appl. No.: 18/967,033

(22) Filed: Dec. 3, 2024

(30) Foreign Application Priority Data
Feb. 2, 2024 (JP) 2024-014935

(51) Int. Cl. H01M 10/0562

(52) U.S. Cl. CPC H01M 10/0562; H01M 2300/0068

(57) ABSTRACT

A solid electrolyte includes Li, a PS₄³⁻ structure, and a BH₄⁻ structure. The following conditions (i) to (iii) are satisfied. Condition (i): In an ¹¹B-NMR measurement, an integral area of a peak α that has a top in a range of 42 ppm±1 ppm is equal to or more than 50% of a total of integral areas of all peaks. Condition (ii): In a ³¹P-NMR measurement, an integral area of a peak β that has a top in a range of 90.5 ppm±1 ppm is equal to or more than 50% of a total of integral areas of all peaks. Condition (iii): In a temperature raising step of a DSC measurement, a heat capacity at an endothermic peak that appears in a range of 115° C.±10° C. is less than 30 J/g.

### CROSS-REFERENCE TO RELATED APPLICATION

This application claims priority to Japanese Patent Application No. 2024-014935 filed on Feb. 2, 2024, incorporated herein by reference in its entirety.

### BACKGROUND

### 1. Technical Field

The present disclosure relates to a solid electrolyte, a composite material, a battery, and a production method for a solid electrolyte.

### 2. Description of Related Art

In recent years, the development of batteries has been actively performed. For example, in the automobile industry, the development of batteries that are used in a battery electric vehicle (BEV), a plug-in hybrid electric vehicle (PHEV), or a hybrid electric vehicle (HEV) has been advanced. Further, an inorganic solid electrolyte is known as an electrolyte that is used in batteries. For example, the inorganic solid electrolyte has an advantage in the simplification of safety equipment, compared to an electrolytic solution (liquid electrolyte) that contains a combustible organic solvent.

For example, Japanese Unexamined Patent Application Publication (Translation of PCT application) No. 2020-534245 discloses a compound expressed as Formula: Li₇₋ₓPS₆₋ₓX_{x-z}(BH₄)_{z} (in the formula, X is selected from the group consisting of Cl, Br, I, F, and CN, 0<x≤2 is satisfied, and 0<z≤0.50 is satisfied).

Japanese Unexamined Patent Application Publication (Translation of PCT application) No. 2023-518850 discloses an argyrodite-type solid electrolyte material that contains Li, T, X, and A. Here, T is at least one kind of element that is selected from the group consisting of P, As, Si, Ge, Al, and B, X is one or more kinds of halogens, BH₄, BF₄, NH₂, NO₃, or a combination of them, and A is one kind or more of S, Se, and N. The above solid electrolyte material has peaks at 2θ=14.6°±0.25°, 15.30°±0.25°, and 25.1°±0.25°, in an X-ray diffraction measurement with Cu-Kα (1, 2)=1.5418 Å.

Japanese Unexamined Patent Application Publication (Translation of PCT application) No. 2023-543227 discloses a solid electrolyte material that contains Li, T, X, and A. Here, T contains at least one kind of element that is selected from the group consisting of Sb, P, As, Si, Ge, Al, B, and W, X contains one or more kinds of halogens or pseudo halogens, or N, and A contains one kind or more of S and Se. The above solid electrolyte material has peaks at 2θ=14.5°±0.50°, 16.8°±0.50°, 23.9°±0.50°, 28.1°±0.50°, and 32.5°±0.50°, in an X-ray diffraction measurement with Cu-Kα (1, 2)=1.54064 Å.

### SUMMARY

At the time of the synthesis of the solid electrolyte, in some cases, some of a raw material remains, or an impurity is produced. When a solid electrolyte containing a large amount of raw material or impurity is used in the battery, a cycle characteristic decreases easily. Specifically, the raw material and the impurity are electrochemically unstable, generally, and therefore, the change in electric potential easily causes oxidation or reduction, resulting in the decrease in cycle characteristic.

The present disclosure provides a solid electrolyte that can restrain the decrease in cycle characteristic.

An aspect of the present disclosure relates to a solid electrolyte including Li, a PS₄³⁻ structure, and a BH₄⁻ structure. The following conditions (i) to (iii) are satisfied.
Condition (i): In an ¹¹B-NMR measurement, an integral area of a peak α that has a top in a range of 42 ppm±1 ppm is equal to or more than 50% of a total of integral areas of all peaks.
Condition (ii): In a ³¹P-NMR measurement, an integral area of a peak β that has a top in a range of 90.5 ppm±1 ppm is equal to or more than 50% of a total of integral areas of all peaks.
Condition (iii): In a temperature raising step of a DSC measurement, a heat capacity at an endothermic peak that appears in a range of 115° C.±10° C. is less than 30 J/g.

The solid electrolyte may include an argyrodite-type crystal phase.

In the Condition (i), the integral area of the peak α may be equal to or more than 90% of the total of the integral areas of all peaks.

In the Condition (ii), the integral area of the peak β may be equal to or more than 90% of the total of the integral areas of all peaks.

In the Condition (iii), the heat capacity at the endothermic peak may be equal to or less than 20 J/g.

The mole fraction of the PS₄³⁻ structure with respect to a total of the PS₄³⁻ structure and the BH₄⁻ structure may be equal to or more than 20% and equal to or less than 40%.

The solid electrolyte may have a composition expressed as xLi₃PS₄₋ (100-x)LiBH₄ (x is equal to or more than 20 and equal to or less than 40).

A second aspect of the present disclosure relates to a composite material containing: the above solid electrolyte; and at least one of an electrode active material, a conductive material, and a binder.

A third aspect of the present disclosure relates to a battery including: a positive electrode layer; a negative electrode layer; and an electrolyte layer disposed between the positive electrode layer and the negative electrode layer. At least one of the positive electrode layer, the negative electrode layer, and the electrolyte layer contains the above composite material.

The electrolyte layer may contain the solid electrolyte.

A fourth aspect of the present disclosure relates to a production method for the above solid electrolyte. The production method includes: preparing a sulfide solid electrolyte having a composition expressed as Li₃PS₄ and a hydride solid electrolyte having a composition expressed as LiBH₄; making a precursor by giving mechanical energy to a raw mixture that contains the sulfide solid electrolyte and the hydride solid electrolyte; and making the solid electrolyte by performing heat treatment of the precursor.

The sulfide solid electrolyte that is prepared may be an amorphous material.

The precursor may be made by giving the mechanical energy to the raw mixture by treating the raw mixture with a planetary ball mill, at a rotation speed equal to or higher than 200 rpm and equal to or lower than 500 rpm, for a time equal to or longer than 1 hour and equal to or shorter than 50 hours.

The solid electrolyte may be made by performing the heat treatment of the precursor, at a temperature equal to or higher than 160° C. and equal to or lower than 250° C., for a time equal to or longer than 1 hour and equal to or shorter than 10 hours.

The solid electrolyte may be made by performing the heat treatment of the precursor under an inert gas atmosphere or a vacuum.

The sulfide solid electrolyte may be Li₃PS₄. The hydride solid electrolyte may be LiBH₄. The mole ratio between Li₃PS₄ and LiBH₄ may be 20 to 33:80 to 67.

The present disclosure exerts an effect of providing the solid electrolyte that can restrain the decrease in cycle characteristic.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view illustrating a battery in the present disclosure;

FIG. 2 is a flowchart illustrating a production method for a solid electrolyte in the present disclosure;

FIG. 3A shows the result of an ¹¹B-NMR measurement for a solid electrolyte obtained in an example 1;

FIG. 3B shows the result of the ¹¹B-NMR measurement for a solid electrolyte obtained in a comparative example 1;

FIG. 3C shows the result of the ¹¹B-NMR measurement for a solid electrolyte obtained in a comparative example 2;

FIG. 4A shows the result of a ³¹P-NMR measurement for the solid electrolyte obtained in the example 1;

FIG. 4B shows the result of the ³¹P-NMR measurement for the solid electrolyte obtained in the comparative example 1;

FIG. 4C shows the result of the ³¹P-NMR measurement for the solid electrolyte obtained in the comparative example 2;

FIG. 5A shows the result of a DSC measurement for the solid electrolyte obtained in the example 1;

FIG. 5B shows the result of the DSC measurement for the solid electrolyte obtained in the comparative example 1; and

FIG. 5C shows the result of the DSC measurement for the solid electrolyte obtained in the comparative example 2.

### DETAILED DESCRIPTION OF EMBODIMENTS

A solid electrolyte, a composite material, a battery, and a production method for the solid electrolyte in the present disclosure will be described below in detail.

### A. Solid Electrolyte

The solid electrolyte in the present disclosure includes Li, a PS₄³⁻ structure, and a BH₄⁻ structure. Furthermore, the solid electrolyte in the present disclosure satisfies the following conditions (i) to (iii).
Condition (i): In an ¹¹B-NMR measurement, an integral area of a peak α that has a top in a range of 42 ppm±1 ppm is equal to or more than 50% of a total of integral areas of all peaks.
Condition (ii): In a ³¹P-NMR measurement, an integral area of a peak β that has a top in a range of 90.5 ppm±1 ppm is equal to or more than 50% of a total of integral areas of all peaks.
Condition (iii): In a temperature raising step of a DSC measurement, a heat capacity at an endothermic peak that appears in a range of 115° C.±10° C. is less than 30 J/g.

In the present disclosure, since the above conditions (i) to (iii) are satisfied, the solid electrolyte can restrain the decrease in cycle characteristic. At the time of the synthesis of a solid electrolyte, in some cases, some of a raw material remains, or an impurity is produced. When a solid electrolyte containing a large amount of raw material or impurity is used in a battery, the cycle characteristic decreases easily. Specifically, the raw material and the impurity are electrochemically unstable, generally, and therefore, the change in electric potential easily causes oxidation or reduction, resulting in the decrease in cycle characteristic. In contrast, in the present disclosure, since the above conditions (i) to (iii) are satisfied, the amount of the raw material that remains in the solid electrolyte is small, and the amount of the impurity that is contained in the solid electrolyte is small. Therefore, it is hard to cause oxidation or reduction due to the change in electric potential, and it is possible to obtain an electrochemically stable solid electrolyte, and to restrain the decrease in cyclic characteristic.

As the Condition (i) in the present disclosure, in the ¹¹B-NMR measurement, the integral area of the peak α that has the top in the range of 42 ppm±1 ppm is equal to or more than 50% of the total of the integral areas of all peaks. The peak α is a peak due to B in the BH₄⁻ structure. The ratio of the integral area of the peak α may be equal to or more than 70%, may be equal to or more than 80%, may be equal to or more than 90%, or may be equal to or more than 95%.

As the Condition (ii) in the present disclosure, in the ³¹P-NMR measurement, the integral area of the peak β that has the top in the range of 90.5 ppm 1 ppm is equal to or more than 50% of the total of the integral areas of all peaks. The peak β is a peak due to P in the PS₄³⁺ structure. The ratio of the integral area of the peak β may be equal to or more than 70%, may be equal to or more than 80%, or may be equal to or more than 90%.

As the Condition (iii) in the present disclosure, in the temperature raising step of the DSC measurement, the heat capacity at the endothermic peak that appears in the range of 115° C.±10° C. is less than 30 J/g. The above Condition (i) is a condition that includes BH₄⁻ contained in the raw material (for example, LiBH₄) that remains in the solid electrolyte. Meanwhile, the raw material that remains in the solid electrolyte, generally, is thermochemically unstable, compared to the targeted solid electrolyte, and therefore, by the DSC measurement, it is possible to distinguish the raw material that remains in the solid electrolyte and the targeted solid electrolyte. The heat capacity at the above endothermic peak may be equal to or less than 25 J/g, or may be equal to or less than 20 J/g.

It is preferable that the solid electrolyte in the present disclosure includes an argyrodite-type crystal phase. By an X-ray diffraction (XRD) measurement, it can be confirmed that the solid electrolyte includes the argyrodite-type crystal phase. It is preferable that the solid electrolyte has peaks at 2θ=17.0°±0.5°, 24.1°±0.5°, 28.3°±0.5°, 29.6°±0.5°, and 38.6°±0.5°, in an XRD measurement with use of a CuKα ray. These peaks are typical peaks for the argyrodite-type crystal phase. Each of the positions of the peaks may be in a range of ±0.3°, or may be in a range of ±0.1°.

It is preferable that the solid electrolyte in the present disclosure contains the argyrodite-type crystal phase as a main phase. The “main phase” is a crystal phase that includes a peak having the highest intensity in the XRD measurement with use of the CuKα ray. Further, in the solid electrolyte, it is preferable that a peak for Li₂S is not observed in the XRD measurement. Similarly, in the solid electrolyte, it is preferable that a peak for P₂S₅ is not observed in the XRD measurement.

In the solid electrolyte, the mole fraction of the PS₄³⁻ structure with respect to the total of the PS₄³⁻ structure and the BH₄⁻ structure is equal to or more than 20%, for example, and may be equal to or more than 23%, or may be equal to or more than 25%. On the other hand, the above mole fraction is equal to or less than 40%, for example, and may be equal to or less than 38%, or may be equal to or less than 35%.

It is preferable that the solid electrolyte has a composition expressed as xLi₃PS₄₋ (100-x)LiBH₄. In this composition, x is generally equal to or more than 20, and may be equal to or more than 23, or may be equal to or more than 25. On the other hand, x is generally equal to or less than 40, and may be equal to or less than 38, or may be equal to or less than 35.

It is preferable that the solid electrolyte in the present disclosure has a high ion conductivity. The ion conductivity at 25° C. is equal to or higher than 1×10⁻⁴ S/cm, for example, and may be equal to or higher than 5×10⁻⁴ S/cm. Further, examples of the form of the solid electrolyte include a particle form. The average particle diameter (D₅₀) of the solid electrolyte is equal to or more than 0.1 μm and equal to or less than 50 μm. The average particle diameter (D₅₀) is a volume accumulation particle diameter that is measured by a laser diffraction-diffusion type particle size distribution measuring device. The use purpose of the solid electrolyte is not particularly limited, and for example, it is preferable that the solid electrolyte is used in batteries.

### B. Composite Material

The composite material in the present disclosure contains the above-described solid electrolyte, and at least one of an electrode active material, a conductive material, an electrolyte, and a binder.

In the present disclosure, by using the above-described solid electrolyte, the composite material can restrain the decrease in cycle characteristic. Further, examples of the composite material in the present disclosure include a positive electrode composite material that is used in a positive electrode layer of the battery, a negative electrode composite material that is used in a negative electrode layer of the battery, and an electrolyte layer composite material that is used on an electrolyte layer of the battery.

### 1. Positive Electrolyte Composite Material

Generally, the positive electrode composite material contains at least the above-described solid electrolyte and a positive electrode active material. The positive electrode composite material may further contain at least one of a conductive material and a binder.

The content about the solid electrolyte is the same as the content described in “A. Solid Electrolyte”. The ratio of the solid electrolyte in the positive electrode composite material is equal to or more than 10 weight %, for example, and may be equal to or more than 20 weight %, or may be equal to or more than 30 weight %. On the other hand, the ratio of the solid electrolyte in the positive electrode composite material is equal to or less than 50 weight %, for example.

Examples of the positive electrode active material include an oxide active material. Examples of the oxide active material include a bedded salt-shaped active material such as LiCoO₂, LiMnO₂, LiNiO₂, LiVO₂, and LiNi_{1/3}Co_{1/3}Mn_{1/3}O₂, a spinel-type active material such as LiMn₂O₄, Li₄Ti₅O₁₂, and Li(Ni_{0.5}Mn_{1.5})O₄, and an olivine-type active material such as LiFePO₄, LiMnPO₄, LiNiPO₄, and LiCoPO₄.

A coat layer containing a Li-ion conductive oxide may be formed on the surface of the oxide active material. This is because the coat layer can restrain the reaction of the oxide active material and the solid electrolyte (particularly, a sulfide solid electrolyte). Examples of the Li-ion conductive oxide include LiNbO₃. The thickness of the coat layer is equal to or more than 1 nm and equal to or less than 30 nm, for example. Further, as the positive electrode active material, for example, Li₂S can be used.

Examples of the form of the positive electrode active material include a particle form. The average particle diameter (D₅₀) of the positive electrode active material, which is not particularly limited, is equal to or more than 10 nm, for example, and may be equal to or more than 100 nm. On the other hand, the average particle diameter (D₅₀) of the positive electrode active material is equal to or less than 50 μm, for example, and may be equal to or less than 20 μm.

The ratio of the positive electrode active material in the positive electrode composite material is equal to or more than 30 weight %, for example, and may be equal to or more than 50 weight %, or may be equal to or more than 70 weight %. On the other hand, the ratio of the positive electrode active material in the positive electrode composite material is equal to or less than 99 weight %, for example.

Examples of the conductive material include a carbon material, a metal particle, and a conductive polymer. Examples of the carbon material include a particulate carbon material such as acetylene black (AB) and Ketjen black (KB), and a fibrous carbon material such as carbon fiber, carbon nanotube (CNT) and carbon nanofiber (CNF). Further, examples of the binder include a rubber binder and a fluoride binder.

### 2. Negative Electrode Composite Material

Generally, the negative electrode composite material contains at least the above-described solid electrolyte and a negative electrode active material. The negative electrode composite material may further contain at least one of a conductive material and a binder.

The content about the solid electrolyte is the same as the content described in “A. Solid Electrolyte”. The ratio of the solid electrolyte in the negative electrode composite material is equal to or more than 10 weight %, for example, and may be equal to or more than 20 weight %, or may be equal to or more than 30 weight %. On the other hand, the ratio of the solid electrolyte in the negative electrode composite material is equal to or less than 50 weight %, for example.

Examples of the negative electrode active material include a Li active material such as Li and a Li alloy, a Si active material, a carbon active material such as graphite, and an oxide active material such as Li₄Ti₅O₁₂. Among them, the negative electrode active material preferably should be the Si active material. This is because the Si active material allows the increase in the capacity of the battery. The Si active material is an active material that contains Si as a main component. The Si active material may be merely Si, may be a Si alloy, or may be a Si oxide. Further, the Si active material may include a diamond-type crystal phase, may include a clathrate I-type crystal phase, or may include a clathrate II-type crystal phase. In the clathrate I-type crystal phase or the clathrate II-type crystal phase, a polyhedron (cage) including a pentagon or hexagon is formed by a plurality of Si elements. This polyhedron has a space capable of including metal ions such as Li ions, in the interior of the polyhedron, and therefore, can restrain the change in volume due to charge and discharge.

Examples of the form of the negative electrode active material include a particle form. The average particle diameter (D₅₀) of the negative electrode active material, which is not particularly limited, is equal to or more than 10 nm, for example, and may be equal to or more than 100 nm. On the other hand, the average particle diameter (D₅₀) of the negative electrode active material is equal to or less than 50 μm, for example, and may be equal to or less than 20 μm.

The ratio of the negative electrode active material in the negative electrode composite material is equal to or more than 30 weight %, for example, and may be equal to or more than 50 weight %, or may be equal to or more than 70 weight %. On the other hand, the ratio of the negative electrode active material in the negative electrode composite material is equal to or less than 99 weight %, for example. Further, the contents about the conductive material and the binder that are used in the negative electrode composite material are the same as the contents described for the above positive electrode composite material.

### 3. Electrolyte Layer Composite Material

For example, the electrolyte layer composite material contains the above-described solid electrolyte and a binder.

The content about the solid electrolyte is the same as the content described in “A. Solid Electrolyte”. The ratio of the solid electrolyte in the electrolyte layer composite material is equal to or more than 70 weight %, for example, and may be equal to or more than 80 weight %, or may be equal to or more than 90 weight %. On the other hand, the ratio of the solid electrolyte in the electrolyte layer composite material is equal to or less than 99 weight %, for example. Further, the content about the biner is the same as the content described for the above positive electrode composite material.

### C. Battery

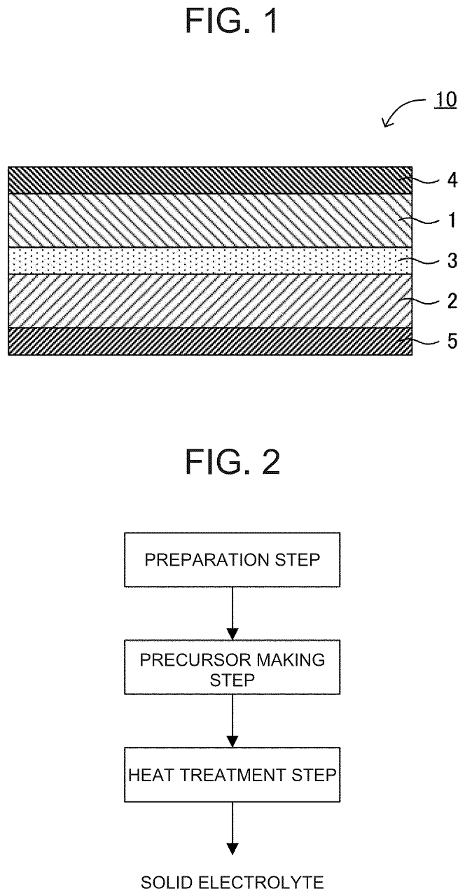

FIG. 1 is a schematic sectional view illustrating the battery in the present disclosure. A battery 10 shown in FIG. 1 includes a positive electrode layer 1 that contains a positive electrode active material, a negative electrode layer 2 that contains a negative electrode active material, an electrolyte layer 3 that is formed between the positive electrode layer 1 and the negative electrode layer 2, a positive electrode current collector 4 that collects electric current from the positive electrode layer 1, and a negative electrode current collector 5 that collects electric current from the negative electrode layer 2. Furthermore, at least one of the positive electrode layer 1, the negative electrode layer 2, and the electrolyte layer 3 contains the composite material described in “B. Composite Material”.

In the present disclosure, by using the above-described composite material, the battery can restrain the decrease in cycle characteristic.

### 1. Positive Electrode Layer, Negative Electrode Layer, and Electrolyte Layer

The positive electrode layer in the present disclosure may contain the above-descried positive electrode composite material. The thickness of the positive electrode layer is equal to or more than 0.1 μm and equal to or less than 1000 μm, for example. Further, the negative electrode layer in the present disclosure may contain the above-described negative electrode composite material. The thickness of the negative electrode layer is equal to or more than 0.1 μm and equal to or less than 1000 μm, for example. Further, the electrolyte layer in the present disclosure may contain the above-described electrolyte layer composite material. The thickness of the electrolyte layer is equal to or more than 0.1 μm and equal to or less than 1000 μm, for example.

### 2. Other Configurations

Generally, the battery in the present disclosure includes a positive electrode current collector that collects electric current from the positive electrode active material and a negative electrode current collector that collects electric current from the negative electrode active material. Examples of the material of the positive electrode current collector include SUS, aluminum, nickel, iron, titanium, and carbon. On the other hand, examples of the material of the negative electrode current collector include SUS, copper, nickel, and carbon.

### 3. Battery

The kind of the battery in the present disclosure is not particularly limited, but is typically a lithium-ion battery. Further, the battery in the present disclosure may be a primary battery or may be a secondary battery, but preferably should be a secondary battery. This is because the secondary battery allows repetitive charge and discharge and is useful as an in-vehicle battery, for example. Further, the battery in the present disclosure may be a solid-state battery in which the electrolyte layer contains a solid electrolyte (particularly, an inorganic solid electrolyte). Examples of the solid-state battery include an all-solid-state battery and a semi-solid-state battery.

For example, the battery is used as an electric power source of a vehicle such as a hybrid electric vehicle (HEV), a plug-in hybrid electric vehicle (PHEV), a battery electric vehicle (BEV), a gasoline vehicle, and a diesel vehicle. Particularly, it is preferable that the battery is used as an electric power source for driving the hybrid electric vehicle (HEV), the plug-in hybrid electric vehicle (PHEV), or the battery electric vehicle (BEV). Further, the battery may be used as an electric power source of a movable body (for example, a train, a ship, or an airplane) other than the vehicle, or may be used as an electric power source of an electric product such as an information processing device. Further, the production method for the battery is not particularly limited, and a known method can be employed.

### D. Production Method for Solid Electrolyte

FIG. 2 is a flowchart illustrating a production method for the solid electrolyte in the present disclosure. As shown in FIG. 2, first, a sulfide solid electrolyte having a composition expressed as Li₃PS₄ and a hydride solid electrolyte having a composition expressed as LiBH₄ are prepared (preparation step). Next, mechanical energy is given to a raw mixture that contains the sulfide solid electrolyte and the hydride solid electrolyte, and thereby, a precursor is made (precursor making step). Next, the heat treatment of the precursor is performed, and thereby, the solid electrolyte described in “A. Solid Electrolyte” is made (heat treatment step).

In the present disclosure, the solid electrolyte that can restrain the decrease in cycle characteristic is obtained by performing the above-described steps. 1. Preparation Step

The preparation step in the present disclosure is a step of preparing the sulfide solid electrolyte having a composition expressed as Li₃PS₄ and the hydride solid electrolyte having a composition expressed as LiBH₄. Each of the sulfide solid electrolyte and the hydride solid electrolyte may be prepared by performing synthesis by oneself, or may be prepared by the purchase from another person.

The sulfide solid electrolyte has a composition expressed as Li₃PS₄. Further, it is preferable that the sulfide solid electrolyte is an amorphous material. In the sulfide solid electrolyte that is an amorphous material, a halo pattern is observed in an XRD measurement with use of a CuKα ray. Further, in the sulfide solid electrolyte, it is preferable that a peak for Li₂S (2θ=27.0°, 31.2°, 44.8°, 53.1°) is not observed in the XRD measurement the use of the CuKα ray. Further, in the sulfide solid electrolyte, in a Raman optical spectrum, when I₄₁₇ represents an intensity at 417 cm⁻¹ and I₄₀₂ represents an intensity at 402 cm⁻¹, I₄₀₂/I₄₁₇ is equal to or less than 50%, for example, and may be equal to or less than 35%. A peak for PS₄ is observed near 417 cm⁻¹, and a peak for S₃P—S—PS₃ is observed at 402 cm⁻¹. Further, at 402 cm⁻¹, a shoulder of the peak for PS₄ and the peak for S₃P—S—PS₃ overlap with each other. Therefore, for example, even when the peak for S₃P—S—PS₃ does not exist, the intensity at 402 cm⁻¹ is high in some degree.

The hydride solid electrolyte has a composition expressed as LiBH₄. LiBH₄ may be a crystalline material, or may be an amorphous material.

### 2. Precursor Making Step

The precursor making step in the present disclosure is a step of making the precursor by giving the mechanical energy to the raw mixture that contains the sulfide solid electrolyte and the hydride solid electrolyte.

The raw mixture may contain only the sulfide solid electrolyte and the hydride solid electrolyte, or may further contain another substance. Examples of the method for giving the mechanical energy include a mechanical milling method with a ball mill, a vibrating mill, or the like. The mechanical milling method may be a dry-type mechanical milling method, or may be a wet-type mechanical milling method. From a standpoint of uniform processing, the wet-type mechanical milling method is preferable. The kind of a dispersion medium that is used for the wet-type mechanical milling method is not particularly limited.

Various conditions for the mechanical milling are set such that a desired precursor is obtained. For example, in the case where a planetary ball mill is used, the raw mixture and a ball for grinding are added in a pot, and the processing is performed at a predetermined rotation speed for a predetermined time. The weighting table rotation speed of the planetary ball mill is equal to or higher than 200 rpm and equal to or lower than 500 rpm, for example. The processing time of the planetary ball mill is equal to or longer than 1 hour and equal to or shorter than 50 hours, for example, and may be equal to or longer than 5 hours and equal to or shorter than 30 hours.

### 3. Heat Treatment Step

The heat treatment step in the present disclosure is a step of making the solid electrolyte by performing the heat treatment of the precursor. For example, it is preferable that the heat treatment temperature is a temperature equal to or higher than the crystallization temperature of the precursor. The heat treatment temperature is equal to or higher than 160° C. and equal to or lower than 250° C., for example. Further, the heat treatment time is equal to or longer than 1 hour and equal to or shorter than 10 hours, for example. Examples of the atmosphere for the heat treatment include an inert gas atmosphere or a vacuum.

### 4. Solid Electrolyte

The content about the solid electrolyte that is obtained by the above-described steps is the same as the content described in “A. Solid Electrolyte”. Further, the present disclosure can provide a production method for a solid electrolyte, including: a preparation step of preparing Li₃PS₄ and LiBH₄; a precursor making step of making a precursor by giving mechanical energy to a raw mixture that contains Li₃PS₄ and LiBH₄; and a heat treatment step of making the solid electrolyte by performing the heat treatment of the precursor, in which the raw mixture has a composition expressed as xLi₃PS₄₋ (100-x)LiBH₄ (x is equal to or more than 20 and equal to or less than 40).

The present disclosure is not limited to the above embodiment. The above embodiment is an example, and the technical scope of the present disclosure includes all embodiments that have configurations substantially identical to technical ideas described in the claims in the present disclosure and that exert the same function effects.

### Example 1

A ZrO₂ ball was added in a 500 ml pot, Li₂S and P₂S₅ were further added at a mole ratio of Li₂S:P₂S₅=3:1, by a total of 30 g, and 100 g of heptane was further added. Next, the pot was set in a planetary ball mill, and ball milling was performed at 300 rpm for 20 hours. Thereby, Li₃PS₄ (sulfide solid electrolyte) that was an amorphous material was synthesized.

Thereafter, LiBH₄ (hydride solid electrolyte) was dried at 150° C. for 1 hour, using a hot plate. A ZrO₂ ball was added in a pot, Li₃PS₄ and LiBH₄ were further added at a mole ratio of Li₃PS₄:LiBH₄=25:75, by a total of 10 g, and 100 g of heptane was further added. Next, the pot was set in a planetary ball mill, and ball milling was performed at 300 rpm for 20 hours, so that a precursor was synthesized. Next, the heat treatment of the precursor was performed at 180° C. for 3 hours, using a hot plate, and thereby, a solid electrolyte was obtained.

### Examples 2, 3 and Comparative Examples 1, 2

Solid electrolytes were obtained similarly to the example 1, except that the ratio between Li₃PS₄ and LiBH₄ was altered to ratios described in Table 1.

### Comparative Example 3

A ZrO₂ ball was added in a 500 ml pot, Li₂S, P₂S₅ and LiBH₄ were further added at a mole ratio of Li₂S:P₂S₅:LiBH₄=18.75:6.25:75, by a total of 10 g, and 100 g of heptane was further added. Next, the pot was set in a planetary ball mill, and ball milling was performed at 300 rpm for 20 hours, so that a precursor was synthesized. Next, the heat treatment of the precursor was performed at 180° C. for 3 hours, using a hot plate, and thereby, a solid electrolyte was obtained.

### Comparative Example 4

A ZrO₂ ball was added in a 500 ml pot, P₂S₅ and LiBH₄ were further added at a mole ratio of P₂S₅:LiBH₄=10:90, by a total of 10 g, and 100 g of heptane was further added. Next, the pot was set in a planetary ball mill, and ball milling was performed at 300 rpm for 20 hours, so that a precursor was synthesized. Next, the heat treatment of the precursor was performed at 200° C. for 3 hours, using a hot plate, and thereby, a solid electrolyte was obtained.

### Evaluation

### ¹¹B-NMR Measurement

The ¹¹B-NMR measurement was performed for the solid electrolytes obtained in the examples 1 to 3 and the comparative examples 1 to 4. The ¹¹B-NMR measurement was performed under the following condition.
Measurement Nuclide: ¹¹B (solid)
Magnetic Field Intensity: 11.747 T (160.36 MHz with ¹¹B nucleus)
Observed Frequency Range: −750 ppm to 750 ppm
Number of Data Points: 2048 points
Measurement Mode: Single pulse
Repetition Time: 1 sec
Number of Accumulations: 128 times
Reference Substance: Adjustment of a shim Z0 based on a signal (29.5 ppm with 13 C
nucleus) for adamantane
Rotation Speed: 18 kHz
Measurement Temperature: Room temperature

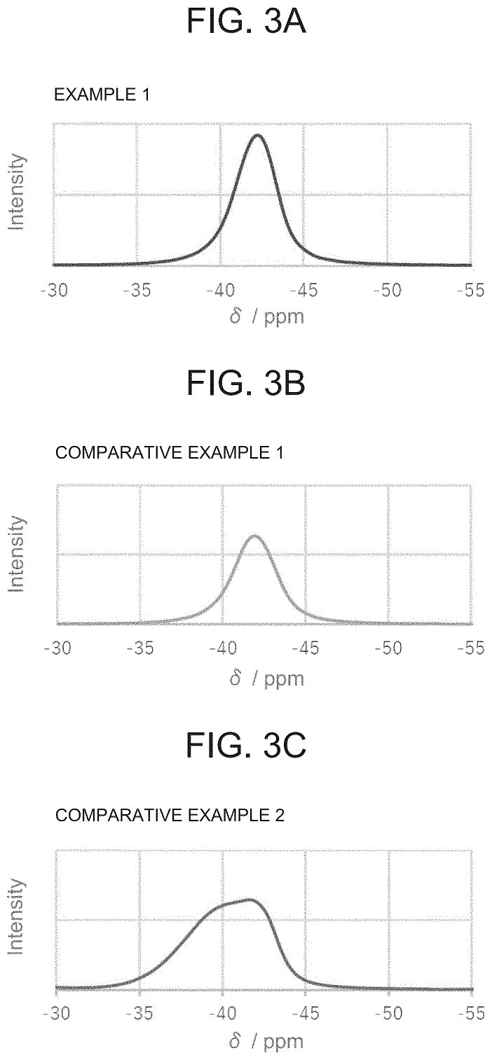

Fitting of obtained peaks was performed, and the ratio (main phase ratio) of the integral area of a peak α having the top in a range of 42 ppm±1 ppm with respect to the total of the integral areas of all peaks was evaluated. The results are shown in Table 1. Further, the results of ¹¹B-NMR measurement for the solid electrolytes obtained in the example 1, the comparative example 1 and the comparative example 2 are shown in FIGS. 3A to 3C, as representative results. As shown in FIGS. 3A and 3B, it was confirmed that the ratio of the integral area of the peak α was high in the example 1 and the comparative example 1. On the other hand, as shown in FIG. 3C, it was confirmed that the ratio of the integral area of the peak α was low and a phase due to an impurity existed in the comparative example 2.

### ³¹P-NMR Measurement

The ³¹P-NMR measurement was performed for the solid electrolytes obtained in the examples 1 to 3 and the comparative examples 1 to 4. The ³¹P-NMR measurement was performed under the following condition.
Measurement Nuclide: ³¹P (solid)
Magnetic Field Intensity: 11.747 T (202.4 MHz with ³¹P nucleus)
Observed Frequency Range: −450 ppm to 550 ppm
Number of Data Points: 2048 points
Measurement Mode: Single pulse
Repetition Time: 300 sec
Number of Accumulations: 64 times (measurement for 5.5 hours)
Reference Substance: Ammonium dihydrogen phosphate (external reference: 1.33 ppm)
Rotation Speed: 18 kHz
Measurement Temperature: Room temperature

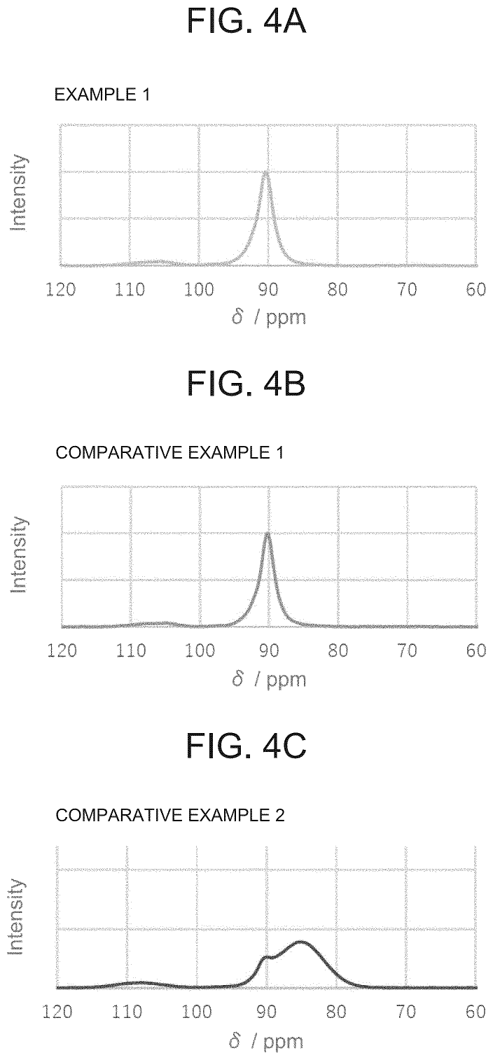

Fitting of obtained peaks was performed, and the ratio (main phase ratio) of the integral area of a peak 3 having the top in a range of 90.5 ppm±1 ppm with respect to the total of the integral areas of all peaks was evaluated. The results are shown in Table 1. Further, the results of the ³¹P-NMR measurement for the solid electrolyte obtained in the example 1, the comparative example 1 and the comparative examples 2 are shown in FIGS. 4A to 4C, as representative results. As shown in FIGS. 4A and 4B, it was confirmed that the ratio of the integral area of the peak 3 was high in the example 1 and the comparative example 1. On the other hand, as shown in FIG. 4C, it was confirmed that the ratio of the integral area of the peak 3 was low and a phase due to an impurity existed in the comparative example 2.

### DSC Measurement

The differential scanning calorimetry (DSC) was performed for the solid electrolytes obtained in the examples 1 to 3 and the comparative examples 1 to 4. The DSC measurement was performed under the following condition.
Device: Shimadzu DSC-60 Plus
Temperature Rising Speed: 10° C./min
Reference Substance: Al₂O₃

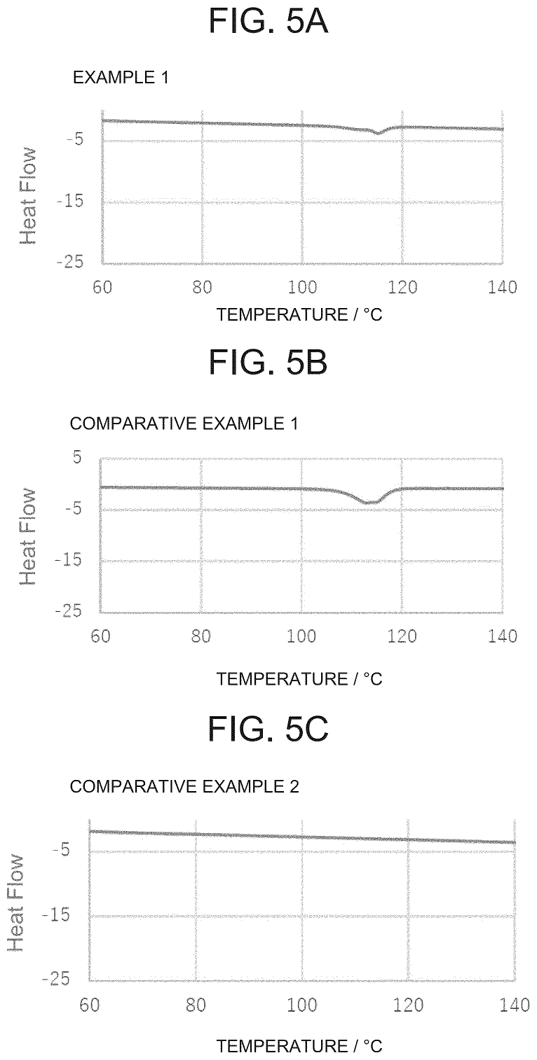

The results are shown in Table 1. Further, the results of the DSC measurement for the solid electrolytes obtained in the example 1, the comparative example 1 and the comparative example 2 are shown in FIGS. 5A to 5C, as representative results. As shown in FIG. 5A, in the example 1, a minute endothermic peak appeared in the range of 115° C.±10° C. Further, as shown in FIG. 5B, in the comparative example 1, a large endothermic peak appeared in the range of 115° C.±10° C., and it was suggested that a large amount of remaining raw material (LiBH₄) was contained. On the other hand, as shown in FIG. 5C, in the comparative example 2, no endothermic peak was found in the range of 115° C.±10° C.

### Capacity Retention Measurement

All-solid-state batteries were made using the solid electrolytes obtained in the examples 1 to 3 and the comparative examples 1 to 4. Specifically, a negative electrode composite material was obtained by mixing the above solid electrolyte, a negative electrode active material (Si), and a conductive material (VGCF). Next, a positive electrode composite material was obtained by mixing the above solid electrolyte, a positive electrode active material (LiNi_{1/3}Co_{1/3}Mn_{1/3}O₂ coated with LiNbO₃), and a conductive material (VGCF). Next, the positive electrode composite material, the above solid electrolyte, and the negative electrode composite material were laminated in an alumina cylinder with ϕ 11.28 mm, and were pressed at a pressure of 6 t, and thereby, a laminated body including a positive electrode layer, a solid electrolyte layer, and a negative electrode layer was obtained. Furthermore, the laminated body was bound at 6 N, and thereby, an all-solid-state battery for evaluation was obtained.

For the obtained all-solid-state battery, a CCCV charge-discharge was repeated at a charge-discharge rate of 1/3 C at room temperature to 50 cycles, and the ratio of the discharge capacity after the 50 cycles with respect to the initial discharge capacity was calculated as a “capacity retention”. The results are shown in Table 1.

TABLE 1

| | | ¹¹B-NMR | ³¹P-NMR | DSC | |
|---|---|---|---|---|---|
| | | Main | Main | Heat | Capacity |
| | | Phase | Phase | Capacity | Retention |
| | Composition | Ratio (%) | Ratio (%) | (J/g) | (%) |
| Example 1 | 25Li₃PS₄—75LiBH₄ | 98 | 91 | 10 | 89 |
| Example 2 | 20Li₃PS₄—80LiBH₄ | 98 | 90 | 20 | 85 |
| Example 3 | 33Li₃PS₄—67LiBH₄ | 50 | 50 | 0 | 81 |
| Comparative | 18Li₃PS₄—82LiBH₄ | 98 | 90 | 30 | 62 |
| Example 1 | | | | | |
| Comparative | 43Li₃PS₄—57LiBH₄ | 29 | 26 | 0 | 50 |
| Example 2 | | | | | |
| Comparative | 25(0.75Li₂S— | 92 | 38 | 0 | 64 |
| Example 3 | 0.25P₂S₅)—75LiBH₄ | | | | |
| Comparative | 10P₂S₅—90LiBH₄ | 64 | 40 | 0 | 56 |
| Example 4 | | | | | |

As shown in Table 1, it was confirmed that the examples 1 to 3 had higher capacity retention and better cycle characteristics than the comparative examples 1 to 4. As for the comparative example 1, it is estimated that the heat capacity at the endothermic peak in the DSC measurement was large, the solid electrolyte contained a large amount of remaining raw material (LiBH₄), and therefore, the capacity retention was low. As for the comparative example 2, it is estimated that the ratios of the integral areas of the peak α and the peak β were small, the solid electrolyte contained a large amount of impurity, and therefore, the capacity retention was low. As for each of the comparative examples 3 and 4, it is estimated that the ratio of the integral area of the peak β was small, the solid electrolyte contained a large amount of impurity, and therefore, the capacity retention was low. In this way, it was confirmed that it was possible to restrain the decrease in cycle characteristic by satisfying the above-described conditions (i) to (iii).

What is claimed is:

1. A solid electrolyte including Li, a PS₄³⁻ structure, and a BH₄⁻ structure,
the following conditions (i) to (iii) being satisfied,
Condition (i): in an ¹¹B-NMR measurement, an integral area of a peak α that has a top in a range of 42 ppm±1 ppm is equal to or more than 50% of a total of integral areas of all peaks,
Condition (ii): in a ³¹P-NMR measurement, an integral area of a peak β that has a top in a range of 90.5 ppm±1 ppm is equal to or more than 50% of a total of integral areas of all peaks, and
Condition (iii): in a temperature raising step of a DSC measurement, a heat capacity at an endothermic peak that appears in a range of 115° C.±10° C. is less than 30 J/g.

2. The solid electrolyte according to claim 1, wherein the solid electrolyte includes an argyrodite-type crystal phase.

3. The solid electrolyte according to claim 1, wherein in the Condition (i), the integral area of the peak α is equal to or more than 90% of the total of the integral areas of all peaks.

4. The solid electrolyte according to claim 1, wherein in the Condition (ii), the integral area of the peak β is equal to or more than 90% of the total of the integral areas of all peaks.

5. The solid electrolyte according to claim 1, wherein in the Condition (iii), the heat capacity at the endothermic peak is equal to or less than 20 J/g.

6. The solid electrolyte according to claim 1, wherein a mole fraction of the PS₄³⁻ structure with respect to a total of the PS₄³⁻ structure and the BH₄⁻ structure is equal to or more than 20% and equal to or less than 40%.

7. The solid electrolyte according to claim 1, wherein the solid electrolyte has a composition expressed as xLi₃PS₄₋ (100-x)LiBH₄, and x is equal to or more than 20 and equal to or less than 40.

8. A composite material containing:
the solid electrolyte according to claim 1; and
at least one of an electrode active material, a conductive material, and a binder.

9. A battery comprising:
a positive electrode layer;
a negative electrode layer; and
an electrolyte layer disposed between the positive electrode layer and the negative electrode layer, wherein
at least one of the positive electrode layer, the negative electrode layer, and the electrolyte layer contains the composite material according to claim 8.

10. The battery according to claim 9, wherein the electrolyte layer contains a solid electrolyte.

11. A production method for the solid electrolyte according to claim 1, comprising:
preparing a sulfide solid electrolyte having a composition expressed as Li₃PS₄ and a hydride solid electrolyte having a composition expressed as LiBH₄;
making a precursor by giving mechanical energy to a raw mixture that contains the sulfide solid electrolyte and the hydride solid electrolyte; and
making the solid electrolyte by performing heat treatment of the precursor.

12. The production method for the solid electrolyte according to claim 11, wherein the sulfide solid electrolyte that is prepared is an amorphous material.

13. The production method for the solid electrolyte according to claim 11, wherein the precursor is made by giving the mechanical energy to the raw mixture by treating the raw mixture with a planetary ball mill, at a rotation speed equal to or higher than 200 rpm and equal to or lower than 500 rpm, for a time equal to or longer than 1 hour and equal to or shorter than 50 hours.

14. The production method for the solid electrolyte according to claim 11, wherein the solid electrolyte is made by performing the heat treatment of the precursor, at a temperature equal to or higher than 160° C. and equal to or lower than 250° C., for a time equal to or longer than 1 hour and equal to or shorter than 10 hours.

15. The production method for the solid electrolyte according to claim 14, wherein the solid electrolyte is made by performing the heat treatment of the precursor under an inert gas atmosphere or a vacuum.

16. The production method for the solid electrolyte according to claim 11, wherein:
the sulfide solid electrolyte is Li₃PS₄;
the hydride solid electrolyte is LiBH₄; and
a mole ratio between Li₃PS₄ and LiBH₄ is 20 to 33:80 to 67.
